(19) United States
(12) Patent Application Publication
(10) Pub. No.: US 2025/0159519 A1
(43) Pub. Date: May 15, 2025

(54) METHOD, DEVICE AND COMPUTER STORAGE MEDIUM OF COMMUNICATION

(71) Applicants: Gang WANG, Beijing (CN); NEC CORPORATION, Tokyo (JP)

(72) Inventor: Gang WANG, Beijing (CN)

(73) Assignee: NEC CORPORATION, Tokyo (JP)

(21) Appl. No.: 18/722,348

(22) PCT Filed: Dec. 20, 2021
(86) PCT No.: PCT/CN2021/139744

§ 371 Date: Jun. 20, 2024

(51) Int. Cl. H04W 24/10; H04W 24/08

(52) U.S. Cl. CPC H04W 24/10; H04W 24/08

(57) ABSTRACT

Embodiments of the present disclosure relate to methods, devices and computer readable media of communication. A terminal device receives a set of measurement configurations; determines aerial state information of the terminal device, the aerial state information comprising at least one of an altitude range, a mobility state or a battery status; and performs radio measurements at least based on a subset of measurement configurations associated with the aerial state information in the set of measurement configurations. In this way, a more precise measurement configuration may be provided.

### FIELD

Embodiments of the present disclosure generally relate to the field of telecommunication, and in particular, to methods, devices and computer storage media of communication for radio measurements.

### BACKGROUND

Currently, aerial user equipment (UE) such as unmanned aerial vehicle (UAV) is highly concerned. Uplink (UL) interference caused by aerial UEs may degrade throughput performance of terrestrial UEs. Increase in resource utilization level further increases interference in the network, which in turn degrades uplink throughput performance of both aerial UEs and terrestrial UEs. In downlink (DL), a percentage of aerial UEs experiencing cell-edge like radio conditions is much higher as compared to terrestrial UEs. In this case, enhancement on radio measurements of aerial UE is needed.

### SUMMARY

In general, embodiments of the present disclosure provide methods, devices and computer storage media of communication.

In a first aspect, there is provided a method of communication. The method comprises: receiving, at a terminal device, a set of measurement configurations; determining aerial state information of the terminal device, the aerial state information comprising at least one of an altitude range, a mobility state or a battery status; and performing radio measurements based on a subset of measurement configurations associated with the aerial state information in the set of measurement configurations

In a second aspect, there is provided a method of communication. The method comprises: transmitting, at a network device, a set of measurement configurations, a subset of measurement configurations in the set of measurement configurations being associated with aerial state information of a terminal device, the aerial state information comprising at least one of an altitude range, a mobility state or a battery status; and receiving results of radio measurements performed based on the subset of measurement configurations.

In a third aspect, there is provided a device of communication. The device comprises a processor configured to perform the method according to the first aspect of the present disclosure.

In a fourth aspect, there is provided a device of communication. The device comprises a processor configured to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

Through the more detailed description of some embodiments of the present disclosure in the accompanying drawings, the above and other objects, features and advantages of the present disclosure will become more apparent, wherein:

FIG. 1 illustrates an example communication environment in which some embodiments of the present disclosure can be implemented;

FIG. 2 illustrates a schematic diagram illustrating a process for communication according to embodiments of the present disclosure;

FIG. 3A illustrates a schematic diagram illustrating an example set of measurement configurations according to embodiments of the present disclosure;

FIG. 3B illustrates a schematic diagram illustrating another example set of measurement configurations according to embodiments of the present disclosure;

FIG. 3C illustrates a schematic diagram illustrating still another example set of measurement configurations according to embodiments of the present disclosure;

FIG. 4 illustrates a schematic diagram illustrating an example of blacklisted and whitelisted cells according to embodiments of the present disclosure;

FIG. 5 illustrates a schematic diagram illustrating an example of up-tilt beam scanning and down-tilt beam scanning in a measurement window according to embodiments of the present disclosure;

FIG. 6 illustrates an example method of communication implemented at a terminal device in accordance with some embodiments of the present disclosure;

FIG. 7 illustrates an example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term ‘terminal device’ refers to any device having wireless or wired communication capabilities. Examples of the terminal device include, but not limited to, UE, personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Generally, radio characteristic of aerial UE may be affect by altitude of the aerial UE. If an altitude of the aerial UE is below a network device serving the aerial UE, radio characteristic of the aerial UE is more like UE on the ground (i.e., terrestrial UE), e.g., multipath transmission and limited neighbor interference. If an altitude of the aerial UE is above the network device, radio characteristic of the aerial UE is different from terrestrial UE, e.g., line of sight transmission and strong neighbor interference. In this case, the network device should track altitude change of a drone to adjust communication mode. Aerial UE may see more cells with similar signal strength and more far away cells than terrestrial UE.

As mentioned above, the UL interference caused by aerial UEs degrades throughput performance of terrestrial UEs. The increase in resource utilization level further increases interference in the network, which in turn degrades uplink throughput performance of both aerial UEs and terrestrial UEs. In the DL, the percentage of aerial UEs experiencing cell-edge like radio conditions (i.e., poor DL signal to interference plus noise ratio (SINR)) is much higher as compared to terrestrial UEs. This is because aerial UEs, due to their high line-of-sight propagation probability, receive DL interference from a larger number of cells than a typical terrestrial UE does. In the DL, there is higher probability that the number of neighbouring cells causing high level of DL interference at the aerial UEs is higher than in the case of terrestrial UEs.

If antennas of a network device are down tilted, aerial UE whose height is above antenna boresight is likely to be served by side lobes of the antennas. Due to the presence of possible nulls in the sidelobes, aerial UE may possibly see a stronger signal from a faraway network device than the one that is geographically closest. Hence, aerial UE may be served by a faraway base station instead of the closest one. DL pathloss and UL pathloss for an aerial UE may differ in some scenarios where reciprocity does not hold e.g., due to different side lobe orientations in UL and DL, or different channel characteristics in a frequency division duplex (FDD) deployment.

A measurement report may not contain measurement results (e.g., reference signal receive power (RSRP)) for all cells significantly interfered by aerial UEs due to limit on the number of reported cells. When the measurement results are ranked at aerial UE by RSRP without considering transmission power of a network device serving the aerial UE, the aerial UE may report the results corresponding to the cells with the highest RSRP. The RSRP and received signal strength indication (RSSI) characteristics of aerial UEs in the air are different from those associated with terrestrial UEs.

The present inventor found that if a network device aims to perform geo-fencing in a certain altitude range, a measurement configuration is unnecessary for those not allowed cells. Further, if up-tilt beam and down-tilt beam scanning in different time domain, aerial UE may not need to use the overall measurement window. In addition, for aerial UE, a measurement reporting should be reduced to improve the UL interference caused by aerial UEs.

In view of the above, embodiments of the present disclosure provide an improved solution of communication for radio measurements so as to solve the above and other potential problems. In this solution, a terminal device determines aerial state information of the terminal device, the aerial state information comprising at least one of an altitude range, a mobility state or a battery status. Then the terminal device performs radio measurements based on a subset of measurement configurations associated with the aerial state information in a configured set of measurement configurations. In other words, a terminal device may have different aerial state information in different conditions, and different aerial state information may be associated with different measurement configurations. A terminal device with certain aerial state information may perform radio measurements only based on one or more measurement configurations associated with the certain aerial state information.

In this way, a more precise measurement configuration may be provided. The measurement configuration may be specific to a UE in certain aerial state. Allowed cell sets may be specific to certain aerial state. Specific synchronization signal/physical broadcast channel (SS/PBCH) block measurement timing configuration (SMTC) for UE in certain aerial state may be configured to setup an SS/PBCH block measurement only for up-tilt beams, and thus power efficiency may be improved. UE at certain aerial state may be configured to setup SS/PBCH block measurement only for up-tilt beams, and thus power efficiency may be improved. A report configuration may be specific to a UE in certain aerial state. For aerial UE, the report quantity may also be reduced by suitable report configuration.

Principle and example embodiments of the present disclosure will be described in detail below with reference to the accompanying drawings.

### Example of Communication Network

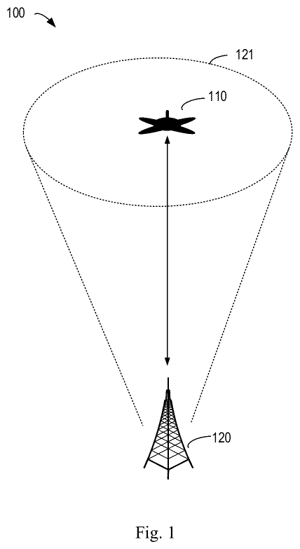

FIG. 1 shows an example communication environment 100 in which example embodiments of the present disclosure can be implemented. The network environment 100 includes a terminal device 110 and a network device 120 serving the terminal device 110. The network device 120 may provide one or more serving cells to the terminal device 110 or any other terminal devices not shown. In the example of FIG. 1, the network device 120 provides a serving cell 121 at an altitude above the network device 120.

For convenience, the following description will be given by assuming that the terminal device 110 is within the serving cell 121 of the network device 120. In the example of FIG. 1, the terminal device 110 is shown as an aerial terminal device. It is to be understood that embodiments of the present disclosure also apply to terrestrial terminal device.

In case that the terminal device 110 is within the serving cell 121 of the network device 120, the terminal device 110 may communicate with the network device 120 via such as a service link or radio link. Communication in a direction from a terminal device 110 towards the network device 120 is referred to as UL communication, while communication in a reverse direction from the network device 120 towards the terminal device 110 is referred to as DL communication.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their connections of network device, terminal device and serving cell are only for the purpose of illustration without suggesting any limitations. The communication environment 100 may include any suitable access network device, terminal device and serving cell adapted for implementing embodiments of the present disclosure.

In some scenarios, the terminal device 110 may receive a measurement configuration from the network device 120 and perform radio measurements based on the measurement configuration. Then the terminal device 110 may report results of the radio measurements to the network device 120.

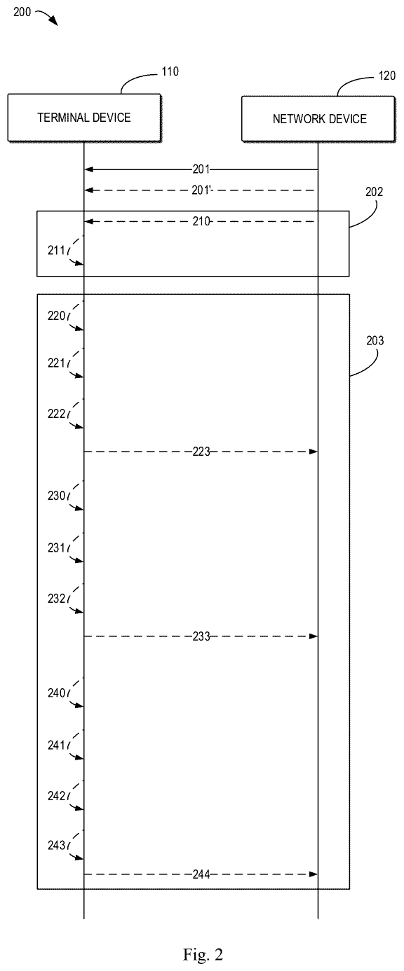

Embodiments of the present disclosure provide an improved solution of communication for radio measurements. This solution will be described in detail with reference to FIGS. 2 to 5.

### Example Implementation of Radio Measurements

FIG. 2 illustrates a schematic diagram illustrating a process 200 for communication according to embodiments of the present disclosure. For the purpose of discussion, the process 200 will be described with reference to FIG. 1. The process 200 may involve the terminal device 110 and the network device 120 as illustrated in FIG. 1.

As shown in FIG. 2, the network device 120 transmits 201, to the terminal device 110, a set of measurement configurations. For example, the network device 120 may transmit the set of measurement configurations in a RRC connection reconfiguration message. It is to be understood that this is merely an example, the set of measurement configurations may be transmitted in any other suitable ways. Further, the set of measurement configurations refers to one or more measurement configurations.

In some embodiments, each measurement configuration in the set of measurement configurations may comprise a measurement identity (ID). The measurement ID is associated with a measurement object and a report configuration. In other words, a measurement configuration may comprise a measurement ID, a measurement object associated with the measurement ID, and a report configuration associated with the measurement ID. It is to be understood that for measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object.

In some embodiments, a measurement configuration in the set of measurement configurations may be associated with certain aerial state information of a terminal device. In some embodiments, the aerial state information may comprise an altitude range. For example, a measurement object and a report configuration associated with a measurement ID with certain altitude range may be only available for UE located in the certain altitude range. As another example, a measurement object and a report configuration associated with a measurement ID without altitude range may be available for all altitudes.

In some embodiments, the altitude range may be divided into N levels by N−1 threshold altitudes, and the threshold altitudes may be predefined or configured by the network device 120. For example, the altitude range may comprise a high location, a medium location, or a low location. If a location of the terminal device 110 is above a first threshold altitude, the altitude range may be estimated as the high location. If the location of the terminal device 110 is below the first threshold altitude and above a second threshold altitude lower than the first threshold altitude, the altitude range may be estimated as the medium location. If the location of the terminal device 110 is below the second threshold altitude, the altitude range may be estimated as the low location.

In some embodiments, the aerial state information may comprise a mobility state. For example, the mobility state may be estimated by the number of cells among which a cell change has been performed during a time period (for convenience, also referred to as a first time period herein). As another example, the mobility state may be estimated by the number of times of the cell change during a time period (for convenience, also referred to as a second time period herein). The cell change may comprise at least one of a handover, a cell selection, or a cell reselection. As still another example, the mobility state may be estimated by a velocity of a terminal device. For example, the velocity may comprise at least one of a vertical velocity or a horizontal velocity. It is to be understood that the mobility state may be estimated by any combination of the above factors and any other suitable factors.

In some embodiments, the mobility state may be divided into N levels by N−1 threshold numbers, and the threshold numbers can be predefined or configured by the network device 120. For example, the mobility state may comprise high mobility, medium mobility, or low mobility. If the number of cell reselections during a time period exceeds a first threshold number, the mobility may be estimated as the high mobility. If the number of cell reselections during the time period is below the first threshold number and exceeds a second threshold number smaller than the first threshold number, the mobility may be estimated as the medium mobility. If the number of cell reselections during the time period is below the second threshold number, the mobility may be estimated as the low mobility.

In some embodiments, the aerial state information may comprise a battery status. In some embodiments, the battery status may be divided into N levels by N−1 threshold power, and the threshold power may be predefined or configured by the network device 120. For example, the battery status may comprise high battery power, medium battery power, or low battery power. If battery power of the terminal device 110 exceeds first threshold power, the battery status may be estimated as the high battery power. If battery power of the terminal device 110 is below the first threshold power and exceeds a second threshold power lower than the first threshold power, the battery status may be estimated as the medium battery power. If the battery power of the terminal device 110 is below the second threshold power, the battery status may be estimated as the low battery power. It is to be understood that the aerial state information may comprise any combination of the above information and any other suitable information.

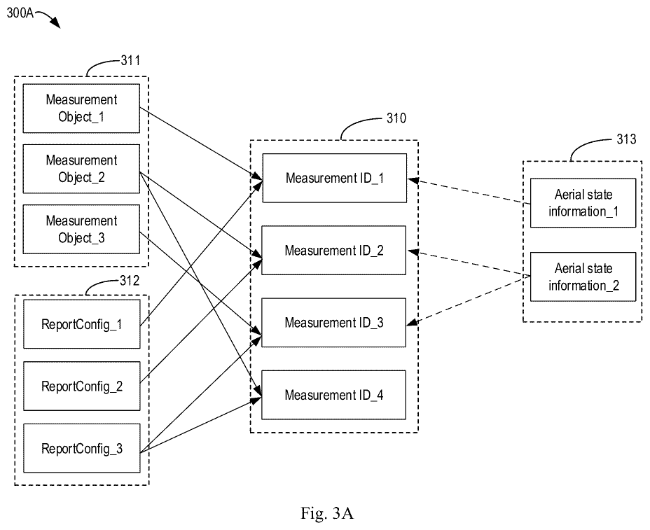

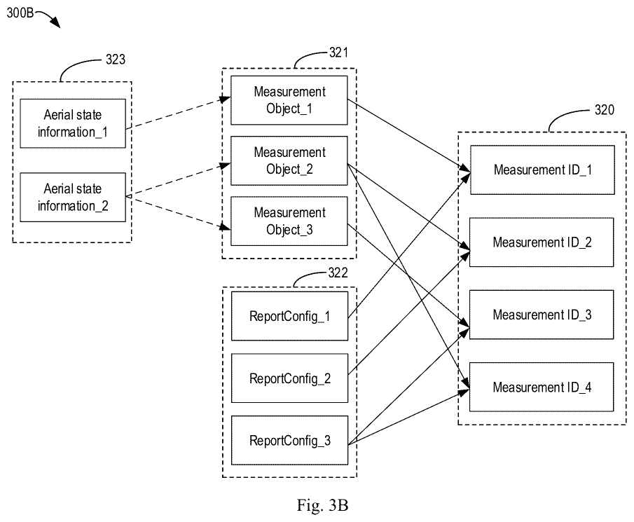

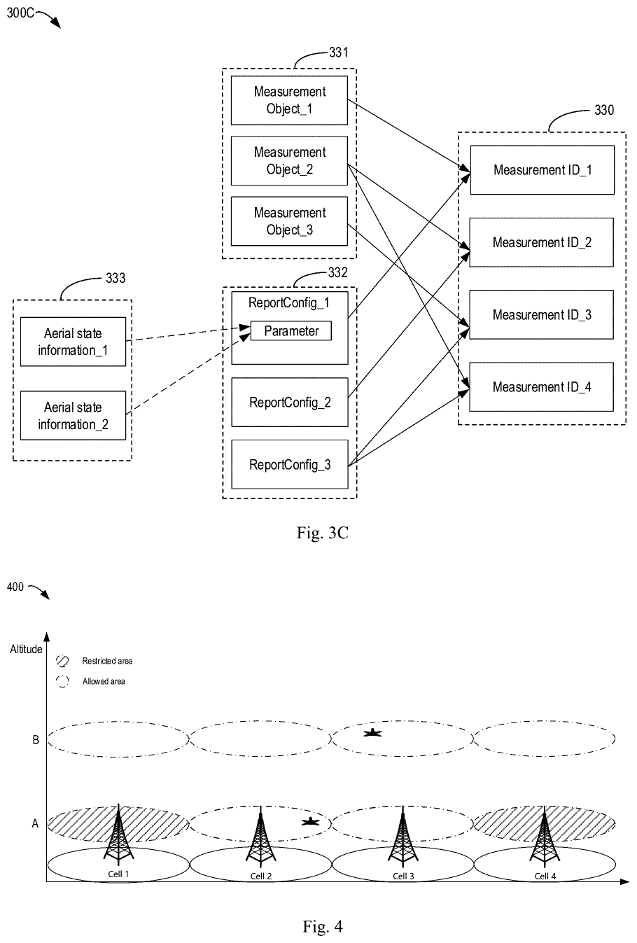

In some embodiments, aerial state information of a terminal device may be associated with one or more measurement IDs. FIG. 3A illustrates a schematic diagram 300A illustrating an example set of measurement configurations according to embodiments of the present disclosure. As shown in FIG. 3A, a set of measurement configurations may comprise a set of measurement IDs 310, a set of measurement objects 311 and a set of report configurations 312. Aerial state information 313 is associated with at least some of the set of measurement IDs 310. In this example, Aerial state information_1 is associated with Measurement ID_1, and Measurement ID_1 is associated with Measurement Object_1 and ReportConfig_1. Aerial state information_2 is associated with Measurement ID_2 and Measurement ID_3, Measurement ID_2 is associated with Measurement Object_2 and ReportConfig_2 and Measurement ID_3 is associated with Measurement Object_3 and ReportConfig_3. Measurement ID_4 is associated with Measurement Object_2 and ReportConfig_3, but is not associated with aerial state information.

In some embodiments, aerial state information of a terminal device may be associated with one or more measurement objects. In some embodiments, the aerial state information may be associated with one or more measurement object IDs comprised in one or more measurement objects. In other words, the aerial state information may be associated with one or more measurement objects identified or presented by measurement object IDs.

FIG. 3B illustrates a schematic diagram 300B illustrating another example set of measurement configurations according to embodiments of the present disclosure. As shown in FIG. 3B, a set of measurement configurations may comprise a set of measurement IDs 320, a set of measurement objects 321 and a set of report configurations 322. Measurement ID_1 is associated with Measurement Object_1 and ReportConfig_1, Measurement ID_2 is associated with Measurement Object_2 and ReportConfig_2, Measurement ID_3 is associated with Measurement Object_3 and ReportConfig_3, and Measurement ID_4 is associated with Measurement Object_2 and ReportConfig_3. Aerial state information 323 is associated with at least some of the set of measurement objects 321. In this example, Aerial state information_1 is associated with a measurement object ID of Measurement Object_1, and Aerial state information_2 is associated with a measurement object ID of Measurement Object_2 and a measurement object ID of Measurement Object_3.

Although not shown in FIG. 3B, different aerial state information may be associated with different values of a configuration parameter in a measurement object. In some embodiments, aerial state information may be associated with a black cell list or a white cell list comprised in a measurement object. In some embodiments, aerial state information may be associated with one or more SMTCs comprised in a measurement object. In some embodiments, aerial state information may be associated with one or more synchronization signal blocks (SSBs) comprised in a measurement object.

In some embodiments, aerial state information of a terminal device may be associated with one or more report configurations. For example, the aerial state information may be associated with a configuration parameter in a report configuration. FIG. 3C illustrates a schematic diagram 300C illustrating still another example set of measurement configurations according to embodiments of the present disclosure. As shown in FIG. 3C, a set of measurement configurations may comprise a set of measurement IDs 330, a set of measurement objects 331 and a set of report configurations 332. Measurement ID_1 is associated with Measurement Object_1 and ReportConfig_1, Measurement ID_2 is associated with Measurement Object_2 and ReportConfig_2, Measurement ID_3 is associated with Measurement Object_3 and ReportConfig_3, and Measurement ID_4 is associated with Measurement Object_2 and ReportConfig_3. Aerial state information 333 is associated with different values of a configuration parameter in a report configuration. In this example, Aerial state information_1 and Aerial state information 2 is associated with different values of a configuration parameter in ReportConfig_1.

In some embodiments, the configuration parameter in a report configuration may indicate whether beam measurements are reported. In some embodiments, the configuration parameter may indicate the number of detected cells that are required to fulfill an event for a measurement report to be triggered. In some embodiments, the configuration parameter may indicate whether only cells included in a white cell list are applicable for the reporting. In some embodiments, the configuration parameter may indicate a timer used to limit subsequent reports.

In some alternative embodiments, a measurement configuration in the set of measurement configurations may be not associated with aerial state information of a terminal device. In this case, the measurement configuration may be used regardless of aerial state information of a terminal device.

Continue to with reference to FIG. 2, the terminal device 110 determines 202 the aerial state information of the terminal device 110. The aerial state information comprises at least one of an altitude range, a mobility state or a battery status.

In some embodiments, the network device 120 may transmit 201′ an indication indicating a determination of aerial state information of the terminal device 110. Upon reception of the indication, the terminal device 110 may determine the aerial state information of the terminal device 110. In some embodiments, if no indication indicating the determination of aerial state information is received, the terminal device 110 may perform radio measurements based on the set of measurement configurations (for example, the set of measurement configurations 320 in FIG. 3) without considering the aerial state information. In some embodiments, the terminal device 110 may determine the aerial state information of the terminal device 110 without the indication.

In some embodiments, the network device 120 may transmit 210, to the terminal device 110, a configuration indicating at least one criterion for determining the aerial state information. For example, different aerial states or aerial state information may be divided by a threshold in a configured list as below.

aerialStateCriterion CHOICE {
altitudeRange Altitude-ThresholdsList
mobilityState Mobility-ThresholdsList
batteryStatus Battery-ThresholdsList
}
altitude-ThresholdsList ::= SEQUENCE (SIZE(1.. maxNrofAlitude-Ranges)) OF
Alitude-Range
mobility-ThresholdsList ::= SEQUENCE (SIZE(1.. maxNrofMobility-Ranges)) OF
Mobility-Range
battery-ThresholdsList ::= SEQUENCE (SIZE(1.. maxNrofBattery-Ranges)) OF
Battery-Range.

Upon reception of the configuration, the terminal device 110 may determine 211 the aerial state information of the terminal device 110 based on the at least one criterion. For example, aerial states or aerial state information associated with more than one criteria may be as below.
Aerial state 1: Altitude below H and horizontal velocity below V
Aerial state 2: Altitude below H and horizontal velocity above V
Aerial state 3: Altitude above H and horizontal velocity below V
Aerial state 4: Altitude above H and horizontal velocity above V.

It is to be understood that any suitable criteria are feasible for the determination of the aerial state information. In some embodiments, the terminal device 110 may determine a mobility state of the terminal device 110 based on at least one of the following: the number of cells among which a cell change has been performed during a first time period, the number of times of the cell change during a second time period, or a velocity of the terminal device 110.

Upon determination of the aerial state information, the terminal device 110 performs 203 radio measurements at least based on a subset of measurement configurations associated with aerial state information in the set of measurement configurations. In some embodiments, the terminal device 110 may perform radio measurements based on the subset of measurement configurations associated with aerial state information in the set of measurement configurations. In some embodiments, the terminal device 110 may perform radio measurements based on the subset of measurement configurations associated with the determined aerial state information in the set of measurement configurations and based on another subset of measurement configurations not associated with any aerial state information in the set of measurement configurations. In the context of the present disclosure, a subset of measurement configurations refers to one or more measurement configurations. For illustration, some example embodiments on the performance of the radio measurements will be described in connection with Embodiments 1 to 6.

### Embodiment 1

In this embodiment, aerial stat information is associated with a set of measurement IDs. The set of measurement IDs refers to one or more measurement IDs. For convenience, this embodiment will be described with reference to FIG. 2 and FIG. 3A.

With reference to FIG. 2, the terminal device 110 may determine 220, from the set of measurement configurations, a set of measurement IDs associated with the determined aerial state information. For each measurement ID in the set of measurement IDs, the terminal device 110 may determine a measurement object and a report configuration associated with the measurement ID. In this way, the terminal device 110 may determine 221 a set of measurement objects and a set of report configurations associated with the set of measurement IDs.

For example, assuming that the aerial state information is Aerial state information 2 as shown in FIG. 3A. The terminal device 110 may determine Measurement ID_2 and Measurement ID_3 associated with Aerial state information 2. Then the terminal device 110 may determine Measurement Object_2 and ReportConfig_2 associated with Measurement ID_2 and Measurement Object_3 and ReportConfig_3 associated with Measurement ID_3.

The terminal device 110 may perform 222 the radio measurements based on the set of measurement objects (for example, Measurement Object_2 and Measurement Object_3) and report 223, to the network device 120, results of the radio measurements based on the set of report configurations (for example, ReportConfig_2 and ReportConfig_3). In this way, a more flexible measurement configuration may be provided. The measurement configuration may be specific to a UE located in certain aerial state.

### Embodiment 2

In this embodiment, aerial stat information is associated with a set of black or white cell lists comprised in a measurement object. The set of black or white cell lists refers to one or more black or white cell lists. For convenience, this embodiment will be described with reference to FIG. 2, FIG. 3B and FIG. 4.

FIG. 4 illustrates a schematic diagram 400 illustrating an example of blacklisted and whitelisted cells according to embodiments of the present disclosure. In this example, different altitudes are associated with different black or white cell lists. As shown in FIG. 4, at altitude A, the black cell list may comprise Cell 1 and Cell 4 as restricted areas. At altitude B, the black cell list may be null. It is to be understood that this is merely an example, and a black or white cell list may also be associated with a velocity or a battery status of a terminal device. Of course, a black or white cell list may also be associated with any combination of two or more of a velocity, a battery status and an altitude of a terminal device.

Return to FIG. 2, the terminal device 110 may determine 230 a set of measurement IDs from the set of measurement configurations. For each measurement ID in the set of measurement IDs, the terminal device 110 may determine a measurement object and a report configuration associated with the measurement ID. In this way, the terminal device 110 may determine 231 a set of measurement objects and a set of report configurations associated with the set of measurement IDs.

For example, for the set of measurement configurations as shown in FIG. 3B, the terminal device 110 may determine Measurement ID_1, Measurement ID_2, Measurement ID_3 and Measurement ID_4. Then the terminal device 110 may determine Measurement Object_1 and ReportConfig_1 associated with Measurement ID_1, Measurement Object_2 and ReportConfig_2 associated with Measurement ID_2, Measurement Object_3 and ReportConfig_3 associated with Measurement ID_3 and Measurement Object_2 and ReportConfig_3 associated with Measurement ID_4.

The terminal device 110 may perform 232 the radio measurements based on the set of measurement objects (for example, Measurement Object_1, Measurement Object_2 and Measurement Object_3). For a measurement object having a set of black or white cell lists associated with aerial state information, the terminal device 110 may determine a subset of black or white cell lists associated with the determined aerial state information from the set of black or white cell lists comprised in the measurement object. As shown in FIG. 4, assuming that the aerial state information is altitude A. The terminal device 110 may determine a black cell list comprising Cell 1 and Cell 4 or a white cell list comprising Cell 2 and Cell 3. Then the terminal device 110 may perform the radio measurements based on the subset of black or white cell lists.

Accordingly, the terminal device 110 may report 233, to the network device 120, results of the radio measurements based on the set of report configurations (for example, ReportConfig_1, ReportConfig_2 and ReportConfig_3).

In this way, a more flexible measurement configuration may also be provided. Allowed cell sets may be specific to certain aerial state. Only allowed cells may trigger event evaluation or measurement reporting and thus geo-fencing for UE in different aerial states may be achieved.

### Embodiment 3

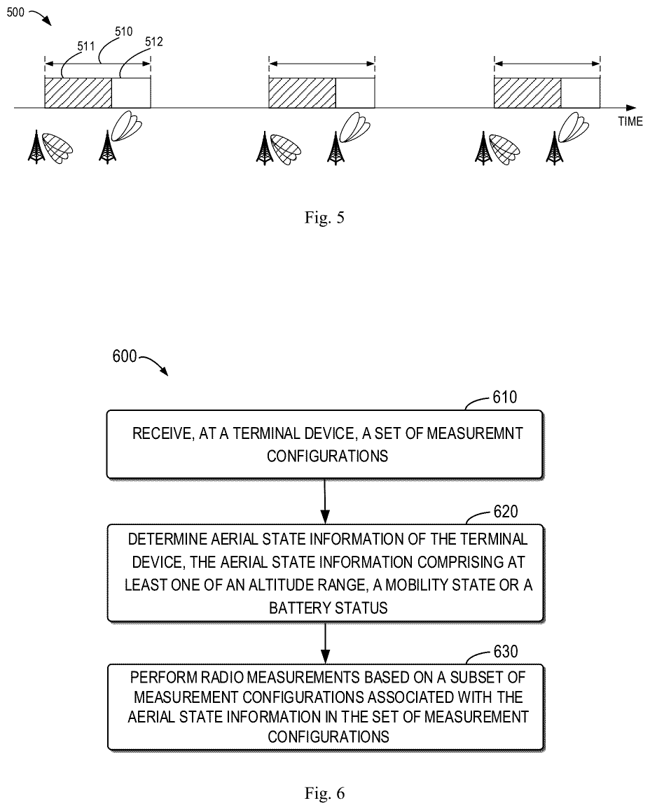

In this embodiment, aerial stat information is associated with a set of SMTCs comprised in a measurement object. The set of SMTCs refers to one or more SMTCs. For convenience, this embodiment will be described with reference to FIG. 3B and FIG. 5.

FIG. 5 illustrates a schematic diagram 500 illustrating an example of up-tilt beam scanning and down-tilt beam scanning in a measurement window according to embodiments of the present disclosure. As shown in FIG. 5, in a measurement window 510, the network device 120 may only perform a down-tilt beam scanning in a time period 511 and may only perform an up-tilt beam scanning in a time period 512. In this case, it is unnecessary for the terminal device 110 to use the overall measurement window for radio measurements.

In some embodiments, the terminal device 110 may determine a set of measurement IDs from the set of measurement configurations. For each measurement ID in the set of measurement IDs, the terminal device 110 may determine a measurement object and a report configuration associated with the measurement ID. In this way, the terminal device 110 may determine a set of measurement objects and a set of report configurations associated with the set of measurement IDs.

For example, for the set of measurement configurations as shown in FIG. 3B, the terminal device 110 may determine Measurement ID_1, Measurement ID_2, Measurement ID_3 and Measurement ID_4. Then the terminal device 110 may determine Measurement Object_1 and ReportConfig_1 associated with Measurement ID_1, Measurement Object_2 and ReportConfig_2 associated with Measurement ID_2, Measurement Object_3 and ReportConfig_3 associated with Measurement ID_3 and Measurement Object_2 and ReportConfig_3 associated with Measurement ID_4.

The terminal device 110 may perform the radio measurements based on the set of measurement objects (for example, Measurement Object_1, Measurement Object_2 and Measurement Object_3). For each measurement object, the terminal device 110 may determine a subset of SMTCs associated with the aerial state information from a set of SMTCs comprised in the measurement object.

In some embodiments, N different SMTC configuration sets may correspond to N altitude ranges. For example, a measurement object may be configured as below. In this case, a terminal device located in a certain altitude range may use a corresponding subset of SMTCs in smtcPerAltitudeRange.

| | |
|---|---|
| MeasObjectNR ::= SEQUENCE { | |
| ssbFrequency | ARFCN-ValueNR |
| ssbSubcarrierSpacing | SubcarrierSpacing |
| smtc1 | SSB-MTC |
| smtc2 | SSB-MTC2 |

smtcPerAltitudeRange SEQUENCE (SIZE (1..maxNrofAlitudeRanges)) OF SSB-MTC
alitude-ThresholdsList ::= SEQUENCE (SIZE(1.. maxNrofAlitudeRanges)) OF
Alitude-Range.

In some embodiments, a specific SMTC configuration may be configured for aerial UE or UE in aerial state. For example, a measurement object may be configured as below. In this case, for example, a terminal device in aerial mode 1 may use a corresponding subset of SMTCs indicated by smtc-AerialMode1 and UE in aerial mode 2 may use a corresponding subset of SMTCs indicated by smtc-AerialMode2.

| MeasObjectNR ::= SEQUENCE { | |
|---|---|
| ssbFrequency | ARFCN-ValueNR |
| ssbSubcarrierSpacing | SubcarrierSpacing |
| smtc1 | SSB-MTC |
| smtc2 | SSB-MTC2 |
| smtc-AerialMode1 | SSB-MTC |
| smtc-AerialMode2 | SSB-MTC. |

In some embodiments, a SMTC configuration with N different offsets may correspond to N altitude ranges. For example, a measurement object may comprise the following configuration. In this case, a terminal device in a certain altitude range may use a corresponding offset indicated in offsetPerAltitudeRange to calculate the start of the SMTC window.

```
SSB-MTC-AERIAL ::= SEQUENCE {
  periodicity ENUMERATED {sf10, sf20, sf40, sf80, sf160, spare3, spare2, spare1}
  duration ENUMERATED { sf1, sf2, sf3, sf4, sf5 }
  offsetPerAltitudeRange SEQUENCE (SIZE (1..maxNrofAlitude-Ranges)) OF offset
  }
offset INTEGER (0.. N).
```

In some embodiments, a further offset for a certain altitude range may be calculated based on an offset configuration in “periodicityAndOffset”. For example, a measurement object may comprise the following configuration. In this case, a terminal device in a certain altitude range may use a corresponding offset to calculate the start of the SMTC window. For example, for a terminal device in aerial mode 1, if periodicityAndOffset is sf20 and 5, and offset-AerialMode1 is 10, the starting point of the SMTC window is 5 subframes+10 subframes=15 subframes.

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79), |
| sf160 | INTEGER (0..159) |

},

| | |
|---|---|
| duration | ENUMERATED { sf1, sf2, sf3, sf4, sf5 } |
| offset-AerialMode1 | INTEGER (0..N) |
| offset-AerialMode2 | INTEGER (0..N) |

}

In this case, a duration for up-tilt beam may also be indicated in SMTC configurations or calculated by equation 1 below.

$$Duration\_AerialMode = duration - offsetAerialMode \qquad ( 1 )$$

where Duration_AerialMode denotes a duration for up-tilt beam, duration denotes a configured duration for radio measurements, and offsetAerialMode denotes a configured offset, for example, indicated by offset-AerialMode1 for a terminal device in aerial mode 1.

Accordingly, the terminal device 110 may report, to the network device 120, results of the radio measurements based on the set of report configurations (for example, ReportConfig_1, ReportConfig_2 and ReportConfig_3).

In this way, a more flexible measurement configuration may also be provided. Further, a specific SMTC may be configured for aerial UE to setup an SS/PBCH block measurement for up-tilt beams.

### Embodiment 4

In this embodiment, aerial stat information is associated with a set of SSBs comprised in a measurement object (for example, SSB-ToMeasure). The set of SSBs refers to one or more SSBs to be measured within a SMTC measurement duration. For convenience, this embodiment will be described with reference to FIG. 3B.

In some embodiments, the terminal device 110 may determine a set of measurement IDs from the set of measurement configurations. For each measurement ID in the set of measurement IDs, the terminal device 110 may determine a measurement object and a report configuration associated with the measurement ID. In this way, the terminal device 110 may determine a set of measurement objects and a set of report configurations associated with the set of measurement IDs.

For example, for the set of measurement configurations as shown in FIG. 3B, the terminal device 110 may determine Measurement ID_1, Measurement ID_2, Measurement ID_3 and Measurement ID_4. Then the terminal device 110 may determine Measurement Object_1 and ReportConfig_1 associated with Measurement ID_1, Measurement Object_2 and ReportConfig_2 associated with Measurement ID_2, Measurement Object_3 and ReportConfig_3 associated with Measurement ID_3 and Measurement Object_2 and ReportConfig_3 associated with Measurement ID_4.

The terminal device 110 may perform the radio measurements based on the set of measurement objects (for example, Measurement Object_1, Measurement Object_2 and Measurement Object_3). For each measurement object, the terminal device 110 may determine a subset of SSBs associated with the aerial state information from a set of SSBs comprised in the measurement object.

In some embodiments, a specific SSB-ToMeasure configuration may be configured for aerial UE or UE in aerial state. For example, a measurement object may comprise the following configuration. In this case, for example, a terminal device in aerial mode 1 may use a corresponding subset of SSB-ToMeasure indicated by ssb-ToMeasure-AerialMode1 and a terminal device in aerial mode 2 may use a corresponding subset of SSB-ToMeasure indicated by ssb-ToMeasure-AerialMode2.

| | |
|---|---|
| SSB-ConfigMobility::= | SEQUENCE { |
| ssb-ToMeasure | SetupRelease { SSB-ToMeasure } |
| ssb-ToMeasure-AerialMode1 | SetupRelease { SSB-ToMeasure } |
| ssb-ToMeasure-AerialMode2 | SetupRelease { SSB-ToMeasure } |

...
}

Accordingly, the terminal device 110 may report, to the network device 120, results of the radio measurements based on the set of report configurations (for example, ReportConfig_1, ReportConfig_2 and ReportConfig_3).

In this way, a more flexible measurement configuration may also be provided. Further, up-tilt beams may be configured for aerial UE to setup an SS/PBCH block measurement.

### Embodiment 5

In this embodiment, aerial stat information is associated with a set of configuration parameters comprised in a report configuration. The set of configuration parameters refers to one or more configuration parameters. For convenience, this embodiment will be described with reference to FIG. 3C.

In some embodiments, the terminal device 110 may determine a set of measurement IDs from the set of measurement configurations. For each measurement ID in the set of measurement IDs, the terminal device 110 may determine a measurement object and a report configuration associated with the measurement ID. In this way, the terminal device 110 may determine a set of measurement objects and a set of report configurations associated with the set of measurement IDs.

For example, for the set of measurement configurations as shown in FIG. 3C, the terminal device 110 may determine Measurement ID_1, Measurement ID_2, Measurement ID_3 and Measurement ID_4. Then the terminal device 110 may determine Measurement Object_1 and ReportConfig_1 associated with Measurement ID_1, Measurement Object_2 and ReportConfig_2 associated with Measurement ID_2, Measurement Object_3 and ReportConfig_3 associated with Measurement ID_3 and Measurement Object_2 and ReportConfig_3 associated with Measurement ID_4.

The terminal device 110 may perform the radio measurements based on the set of measurement objects (for example, Measurement Object_1, Measurement Object_2 and Measurement Object_3).

Then the terminal device 110 may determine a subset of configuration parameters associated with the determined aerial state information from the set of configuration parameters. The subset of configuration parameters refers to one or more configuration parameters. In some embodiments, the set of configuration parameters may comprise a configuration parameter (for example, includeBeamMeasurements comprised in PeriodicalReportConfig) indicating whether beam measurements are reported. In some embodiments, the set of configuration parameters may comprise a configuration parameter (for example, numberOfTriggeringCells comprised in EventTriggerConfig) indicating whether the number of detected cells that are required to fulfill an event for a measurement report to be triggered. In some embodiments, the set of configuration parameters may comprise a configuration parameter (for example, useWhiteCellList comprised in EventTriggerConfig) indicating whether only cells included in a white cell list are applicable for the reporting. In some embodiments, the set of configuration parameters may comprise a configuration parameter (for example, a prohibit timer to limit subsequent reports comprised in EventTriggerConfig) indicating a timer used to limit subsequent reports.

Then the terminal device 110 may report, to the network device 120, results of the radio measurements based on the subset of configuration parameters. In this way, a more flexible measurement configuration may also be provided. Further, the configuration may be specific to UE at certain aerial state.

### Embodiment 6

In this embodiment, aerial stat information is associated with a set of measurement object IDs comprised in respective measurement objects. The set of measurement object IDs refers to one or more measurement object IDs. For example, a measurement object may be configured as below.

| MeasObjectToAddMod ::= | SEQUENCE { |
|---|---|
| measObjectId | MeasObjectId, |
| measObject | CHOICE { |
| measObjectNR | MeasObjectNR, |
| ..., | |
| measObjectEUTRA | MeasObjectEUTRA, |
| measObjectUTRA-FDD-r16 | |
| MeasObjectUTRA-FDD-r16, | |
| measObjectNR-SL-r16 | MeasObjectNR-SL-r16, |
| measObjectCLI-r16 | MeasObjectCLI-r16 |

}
}

For convenience, the following description will be given with reference to FIG. 2 and FIG. 3B. As shown in FIG. 2, the terminal device 110 may determine 240 a set of measurement objects from the set of measurement configurations, a measurement object in the set of measurement objects comprising a measurement object identity associated with the aerial state information. With reference to FIG. 3B, assuming that the aerial state information is Aerial state information 2. The terminal device 110 may determine Measurement Object_2 and Measurement Object_3 associated with Aerial state information 2.

Then the terminal device 110 may determine 241 a set of measurement IDs associated with the set of measurement objects. Continue to with reference to FIG. 3B, the terminal device 110 may determine Measurement ID_2 and Measurement ID_4 associated with Measurement Object_2 and Measurement ID_3 associated with Measurement Object_3. That is, the terminal device 110 may determine Measurement ID_2, Measurement ID_3 and Measurement ID_4 as the set of measurement IDs.

The terminal device 110 may determine 242 a set of report configurations associated with the set of measurement IDs. Continue to with reference to FIG. 3B, the terminal device 110 may determine ReportConfig_2 associated with Measurement ID_2 and ReportConfig_3 associated with Measurement ID_3 and Measurement ID_4. That is, the terminal device 110 may determine ReportConfig_2 and ReportConfig_3 as the set of report configurations.

Then the terminal device 110 may perform 243 the radio measurements based on the set of measurement objects (for example, Measurement Object_2 and Measurement Object_3), and report 244 results of the radio measurements based on the set of report configurations (for example, ReportConfig_2 and ReportConfig_3).

In this way, a more flexible measurement configuration may also be provided. Further, the configuration may be specific to UE at certain aerial state.

So far, the performance of the radio measurements is described. It is to be understood that Embodiments 1 to 6 described above may be carried out separately or in any suitable combination.

### Example Implementation of Methods

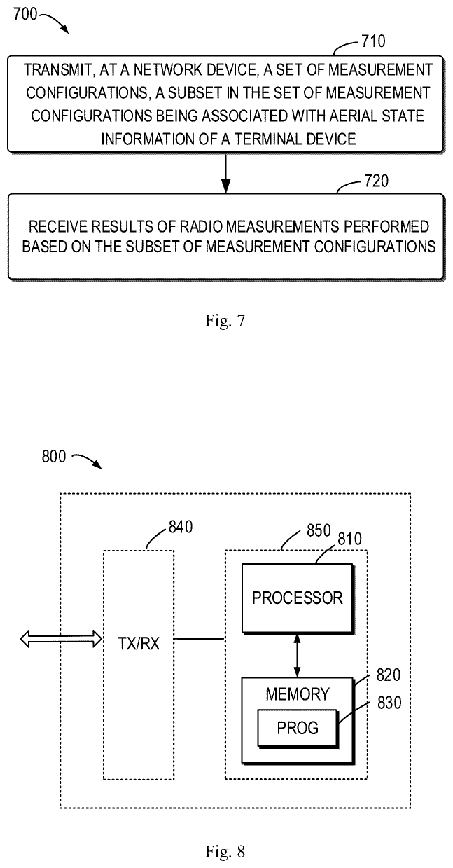

Accordingly, embodiments of the present disclosure provide methods of communication implemented at a terminal device and a network device. These methods will be described below with reference to FIGS. 6 to 7.

FIG. 6 illustrates an example method 600 of communication implemented at a terminal device in accordance with some embodiments of the present disclosure. For example, the method 600 may be performed at the terminal device 110 as shown in FIG. 1. For the purpose of discussion, in the following, the method 600 will be described with reference to FIG. 1. It is to be understood that the method 600 may include additional blocks not shown and/or may omit some blocks as shown, and the scope of the present disclosure is not limited in this regard.

At block 610, the terminal device 110 receives a set of measurement configurations. In some embodiments, the terminal device 110 may receive the set of measurement configurations from the network device 120. Of course, the terminal device 110 may also receive the set of measurement configurations from any other suitable devices.

At block 620, the terminal device 110 determines aerial state information of the terminal device 110. The aerial state information comprises at least one of an altitude range, a mobility state or a battery status. In some embodiments, the terminal device 110 may receive an indication indicating the determination of the aerial state information, and determine the aerial state information based on the reception of the indication. In some embodiments, the terminal device 110 may receive the indication from the network device 120. Of course, the terminal device 110 may also receive the indication from any other suitable devices.

In some embodiments, the terminal device 110 may determine the mobility state based on at least one of the following: the number of cells among which a cell change has been performed during a first time period, the number of times of the cell change during a second time period, or a velocity of the terminal device 110. In some embodiments, the terminal device 110 may receive a configuration indicating at least one criterion for determining the aerial state information, and determine the aerial state information based on the at least one criterion.

At block 630, the terminal device 110 performs radio measurements at least based on a subset of measurement configurations associated with the aerial state information in the set of measurement configurations. In some embodiments, a measurement configuration in the set of measurement configurations may comprise a measurement identity, a measurement object associated with the measurement identity, and a report configuration associated with the measurement identity.

In some embodiments, the terminal device 110 may determine a set of measurement identities associated with the aerial state information; determine a set of measurement objects and a set of report configurations associated with the set of measurement identities; performs the radio measurements based on the set of measurement objects; and reports results of the radio measurements based on the set of report configurations. In some embodiments, the terminal device 110 may report the results of the radio measurements to the network device 120. Of course, the terminal device 110 may also report the results of the radio measurements to any other suitable devices.

In some embodiments, the terminal device 110 may determine a set of measurement identities from the set of measurement configurations; determine a set of measurement objects and a set of report configurations associated with the set of measurement identities; performs the radio measurements based on the set of measurement objects; and reports results of the radio measurements based on the set of report configurations. In some embodiments, the terminal device 110 may report the results of the radio measurements to the network device 120. Of course, the terminal device 110 may also report the results of the radio measurements to any other suitable devices.

In some embodiments, a measurement object in the set of measurement objects comprises a set of black or white cell lists. In these embodiments, the terminal device 110 may determine a subset of black or white cell lists associated with the aerial state information from the set of black or white cell lists, and perform the radio measurements based on the subset of black or white cell lists.

In some embodiments, a measurement object in the set of measurement objects comprises a set of SMTCs. In these embodiments, the terminal device 110 may determine a subset of SMTCs associated with the aerial state information from the set of SMTCs, and perform the radio measurements based on the subset of SMTCs.

In some embodiments, a measurement object in the set of measurement objects comprises a set of SSBs. In these embodiments, the terminal device 110 may determine a subset of SSBs associated with the aerial state information from the set of SSBs, and perform the radio measurements based on the subset of SSBs.

In some embodiments, a report configuration in the set of report configurations comprises a set of configuration parameters. The set of configuration parameters indicates one of the following: whether beam measurements are reported; the number of detected cells that are required to fulfill an event for a measurement report to be triggered; whether only cells included in a white cell list are applicable for the reporting; or a timer used to limit subsequent reports. In these embodiments, the terminal device 110 may determine a subset of configuration parameters associated with the aerial state information from the set of configuration parameters, and report the results of the radio measurements based on the subset of configuration parameters.

In some embodiments, the terminal device 110 may determine a set of measurement objects from the set of measurement configurations, a measurement object in the set of measurement objects comprising a measurement object identity associated with the aerial state information, determine a set of measurement identities associated with the set of measurement objects, determine a set of report configurations associated with the set of measurement identities, perform the radio measurements based on the set of measurement objects, and report results of the radio measurements based on the set of report configurations. In some embodiments, the terminal device 110 may report the results of the radio measurements to the network device 120. Of course, the terminal device 110 may also report the results of the radio measurements to any other suitable devices.

With the method of FIG. 6, a more flexible and effective radio measurements may be achieved and UL interference caused by aerial UEs may be improved.

FIG. 7 illustrates an example method 700 of communication implemented at a network device in accordance with some embodiments of the present disclosure. For example, the method 700 may be performed at the network device 120 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the network device 120 may transmit a set of measurement configurations. A subset of measurement configurations in the set of measurement configurations is associated with aerial state information of a terminal device. The aerial state information comprises at least one of an altitude range, a mobility state or a battery status. In some embodiments, the network device 120 may transmit the set of measurement configurations to the terminal device 110. It is to be understood that the network device 120 may transmit the set of measurement configurations to any other suitable devices.

At block 710, the network device 120 may receive results of radio measurements performed based on the subset of measurement configurations. In some embodiments, the network device 120 may receive the results of radio measurements from the terminal device 110. It is to be understood that the network device 120 may transmit the results of radio measurements to any other suitable devices.

In some embodiments, the network device 120 may transmit a configuration indicating at least one criterion for determining the aerial state information.

In some embodiments, a measurement configuration in the set of measurement configurations comprises a measurement identity, a measurement object associated with the measurement identity, and a report configuration associated with the measurement identity. In some embodiments, the measurement identity is associated with the aerial state information. In some embodiments, the measurement object comprises at least one of the following: a black or white cell list associated with the aerial state information, a SMTC associated with the aerial state information, a SSB associated with the aerial state information, or a measurement object ID associated with the aerial state information. In some embodiments, the report configuration comprises a configuration parameter associated with the aerial state information, the configuration parameter indicating one of the following: whether beam measurements are reported; the number of detected cells that are required to fulfill an event for a measurement report to be triggered; whether only cells included in a white cell list are applicable for the reporting; or a timer used to limit subsequent reports.

In some embodiments, the network device 120 may transmit an indication indicating a determination of the aerial state information.

With the method 700, a more flexible measurement configuration may be provided and a more effective radio measurement results may be obtained.

### Example Implementation of Device and Apparatus

FIG. 8 is a simplified block diagram of a device 800 that is suitable for implementing embodiments of the present disclosure. The device 800 can be considered as a further example implementation of the terminal device 110 or the network device 120 as shown in FIG. 1. Accordingly, the device 800 can be implemented at or as at least a part of the terminal device 110 or the network device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

In some embodiments, a terminal device comprises a circuitry configured to: receive a set of measurement configurations; determine aerial state information of the terminal device, the aerial state information comprising at least one of an altitude range, a mobility state or a battery status; and perform radio measurements at least based on a subset of measurement configurations associated with the aerial state information in the set of measurement configurations.

In some embodiments, the circuitry may be configured to determine the mobility state based on at least one of the following: the number of cells among which a cell change has been performed during a first time period, the number of times of the cell change during a second time period, or a velocity of the terminal device.

In some embodiments, the circuitry may be configured to determine the aerial state information by: receiving a configuration indicating at least one criterion for determining the aerial state information; and determining the aerial state information based on the at least one criterion.

In some embodiments, a measurement configuration in the set of measurement configurations comprises a measurement identity, a measurement object associated with the measurement identity, and a report configuration associated with the measurement identity.

In some embodiments, the circuitry may be configured to perform the radio measurements by: determining a set of measurement identities associated with the aerial state information; determining a set of measurement objects and a set of report configurations associated with the set of measurement identities; performing the radio measurements based on the set of measurement objects; and reporting results of the radio measurements based on the set of report configurations.

In some embodiments, the circuitry may be configured to perform the radio measurements by: determining a set of measurement identities from the set of measurement configurations; determining a set of measurement objects and a set of report configurations associated with the set of measurement identities; performing the radio measurements based on the set of measurement objects; and reporting results of the radio measurements based on the set of report configurations.

In some embodiments, a measurement object in the set of measurement objects comprises a set of black or white cell lists. In these embodiments, the circuitry may be configured to perform the radio measurements by: determining a subset of black or white cell lists associated with the aerial state information from the set of black or white cell lists; and performing the radio measurements based on the subset of black or white cell lists.

In some embodiments, a measurement object in the set of measurement objects comprises a set of SMTCs. In these embodiments, the circuitry may be configured to perform the radio measurements by: determining a subset of SMTCs associated with the aerial state information from the set of SMTCs; and performing the radio measurements based on the subset of SMTCs.

In some embodiments, a measurement object in the set of measurement objects comprises a set of SSBs. In these embodiments, the circuitry may be configured to perform the radio measurements by: determining a subset of SSBs associated with the aerial state information from the set of SSBs; and performing the radio measurements based on the subset of SSBs.

In some embodiments, a report configuration in the set of report configurations comprises a set of configuration parameters. In these embodiments, the circuitry may be configured to report the results of the radio measurements by: determining a subset of configuration parameters associated with the aerial state information from the set of configuration parameters; and reporting the results of the radio measurements based on the subset of configuration parameters, wherein the set of configuration parameters indicates one of the following: whether beam measurements are reported; the number of detected cells that are required to fulfill an event for a measurement report to be triggered; whether only cells included in a white cell list are applicable for the reporting; or a timer used to limit subsequent reports.

In some embodiments, the circuitry may be configured to perform the radio measurements by: determining a set of measurement objects from the set of measurement configurations, a measurement object in the set of measurement objects comprising a measurement object identity associated with the aerial state information; determining a set of measurement identities associated with the set of measurement objects; determining a set of report configurations associated with the set of measurement identities; performing the radio measurements based on the set of measurement objects; and reporting results of the radio measurements based on the set of report configurations.

In some embodiments, the circuitry may be configured to determine the aerial state information by: receiving an indication indicating the determination of the aerial state information; and determining the aerial state information based on the reception of the indication.

In some embodiments, a network device comprises a circuitry configured to: transmit a set of measurement configurations, a subset of measurement configurations in the set of measurement configurations being associated with aerial state information of a terminal device, the aerial state information comprising at least one of an altitude range, a mobility state or a battery status; and receive results of radio measurements performed based on the subset of measurement configurations.

In some embodiments, the circuitry may be further configured to transmit a configuration indicating at least one criterion for determining the aerial state information.

In some embodiments, a measurement configuration in the set of measurement configurations comprises a measurement identity, a measurement object associated with the measurement identity, and a report configuration associated with the measurement identity.

In some embodiments, the measurement identity is associated with the aerial state information. In some embodiments, the measurement object comprises at least one of the following: a black or white cell list associated with the aerial state information, a SMTC associated with the aerial state information, a SSB associated with the aerial state information, or a measurement object identity associated with the aerial state information.

In some embodiments, the report configuration comprises a configuration parameter associated with the aerial state information, the configuration parameter indicating one of the following: whether beam measurements are reported; the number of detected cells that are required to fulfill an event for a measurement report to be triggered; whether only cells included in a white cell list are applicable for the reporting; or a timer used to limit subsequent reports.

In some embodiments, the circuitry may be further configured to transmit an indication indicating a determination of the aerial state information.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
receiving, at a terminal device, a set of measurement configurations;
determining aerial state information of the terminal device, the aerial state information comprising at least one of an altitude range, a mobility state or a battery status; and
performing radio measurements at least based on a subset of measurement configurations associated with the aerial state information in the set of measurement configurations.

2. The method of claim 1, wherein determining the aerial state information comprises determining the mobility state based on at least one of the following:
the number of cells among which a cell change has been performed during a first time period,
the number of times of the cell change during a second time period, or a velocity of the terminal device.

3. The method of claim 1, wherein determining the aerial state information comprises:
receiving a configuration indicating at least one criterion for determining the aerial state information; and
determining the aerial state information based on the at least one criterion.

4. The method of claim 1, wherein a measurement configuration in the set of measurement configurations comprises a measurement identity, a measurement object associated with the measurement identity, and a report configuration associated with the measurement identity.

5. The method of claim 4, wherein the performing comprises:
determining a set of measurement identities associated with the aerial state information;
determining a set of measurement objects and a set of report configurations associated with the set of measurement identities;
performing the radio measurements based on the set of measurement objects; and
reporting results of the radio measurements based on the set of report configurations.

6. The method of claim 4, wherein the performing comprises:
determining a set of measurement identities from the set of measurement configurations;
determining a set of measurement objects and a set of report configurations associated with the set of measurement identities;
performing the radio measurements based on the set of measurement objects; and
reporting results of the radio measurements based on the set of report configurations.

7. The method of claim 6, wherein a measurement object in the set of measurement objects comprises a set of black or white cell lists, and wherein performing the radio measurements comprises:
determining a subset of black or white cell lists associated with the aerial state information from the set of black or white cell lists; and
performing the radio measurements based on the subset of black or white cell lists.

8. The method of claim 6, wherein a measurement object in the set of measurement objects comprises a set of synchronization signal/physical broadcast channel (SS/PBCH) block measurement timing configurations (SMTCs), and wherein performing the radio measurements comprises:
determining a subset of SMTCs associated with the aerial state information from the set of SMTCs; and
performing the radio measurements based on the subset of SMTCs.

9. The method of claim 6, wherein a measurement object in the set of measurement objects comprises a set of synchronization signal blocks (SSBs), and wherein performing the radio measurements comprises:
determining a subset of SSBs associated with the aerial state information from the set of SSBs; and
performing the radio measurements based on the subset of SSBs.

10. The method of claim 6, wherein a report configuration in the set of report configurations comprises a set of configuration parameters, and wherein reporting the results of the radio measurements comprises:
determining a subset of configuration parameters associated with the aerial state information from the set of configuration parameters; and
reporting the results of the radio measurements based on the subset of configuration parameters,
wherein the set of configuration parameters indicates one of the following:
whether beam measurements are reported;
the number of detected cells that are required to fulfill an event for a measurement report to be triggered;
whether only cells included in a white cell list are applicable for the reporting; or
a timer used to limit subsequent reports.

11. The method of claim 4, wherein the performing comprises:
determining a set of measurement objects from the set of measurement configurations, a measurement object in the set of measurement objects comprising a measurement object identity associated with the aerial state information;
determining a set of measurement identities associated with the set of measurement objects;
determining a set of report configurations associated with the set of measurement identities;
performing the radio measurements based on the set of measurement objects; and
reporting results of the radio measurements based on the set of report configurations.

12. The method of claim 1, wherein the determining comprises:
receiving an indication indicating the determination of the aerial state information; and
determining the aerial state information based on the reception of the indication.

13. A method of communication, comprising:
transmitting, at a network device, a set of measurement configurations, a subset of measurement configurations in the set of measurement configurations being associated with aerial state information of a terminal device, the aerial state information comprising at least one of an altitude range, a mobility state or a battery status; and
receiving results of radio measurements performed based on the subset of measurement configurations.

14. The method of claim 13, further comprising:
transmitting a configuration indicating at least one criterion for determining the aerial state information.

15. The method of claim 13, wherein a measurement configuration in the set of measurement configurations comprises a measurement identity, a measurement object associated with the measurement identity, and a report configuration associated with the measurement identity.

16. The method of claim 15, wherein the measurement identity is associated with the aerial state information.

17. The method of claim 15, wherein the measurement object comprises at least one of the following:
a black or white cell list associated with the aerial state information,
a synchronization signal/physical broadcast channel (SS/PBCH) block measurement timing configuration (SMTC) associated with the aerial state information,
a synchronization signal block (SSB) associated with the aerial state information, or
a measurement object identity associated with the aerial state information.

18. The method of claim 15, wherein the report configuration comprises a configuration parameter associated with the aerial state information, the configuration parameter indicating one of the following:
whether beam measurements are reported;
the number of detected cells that are required to fulfill an event for a measurement report to be triggered;
whether only cells included in a white cell list are applicable for the reporting; or
a timer used to limit subsequent reports.

19. The method of claim 13, further comprising:
transmitting an indication indicating a determination of the aerial state information.

20. A terminal device comprising:
a processor configured to perform the method according to any of claims 1-12.

21. A network device comprising:
a processor configured to perform the method according to any of claims 13-19.
